(19) United States
(12) Patent Application Publication
(10) Pub. No.: US 2014/0162698 A1
(43) Pub. Date: Jun. 12, 2014

(54) GROUP-BASED SOCIAL INTERACTION USING LOCATION-AWARE MOBILE DEVICES

(71) Applicant: Yui Han, Edmonton (CA)

(72) Inventor: Yui Han, Edmonton (CA)

(21) Appl. No.: 14/232,590

(22) PCT Filed: Jul. 13, 2012
(86) PCT No.: PCT/CA2012/050485

§ 371 Date: Jan. 13, 2014

Related U.S. Application Data
(60) Provisional application No. 61/507,587, filed on Jul. 13, 2011.

(51) Int. Cl. H04W 4/08; H04W 4/02

(52) U.S. Cl. CPC H04W 4/08; H04W 4/023
USPC 455/456.3; 455/519

(57) ABSTRACT

A method of social interaction has the steps of providing a network having a set of mobile devices associated with individuals; identifying a plurality of units of at least one subset of the set of mobile devices, at least one unit of the plurality of units comprising a group of mobile devices formed based on common social connections between individuals; characterizing the units by one or more characteristics; ranking a compatibility of units by comparing the one or more characteristics; causing at least one invitation or message to be transmitted over the network from a sending unit to a receiving unit; and sharing contact information of the units once an invitation has been accepted.

### FIELD

This relates to a method and apparatus for facilitating or initiating group-based social interactions using location-aware mobile devices.

### BACKGROUND

United States Pre-Grant Publication No. 20110142016 (Chatterjee), entitled “Ad hoc networking based on content and location,” describes a method of determining compatibility of two individuals, and provides a means of initiating communication between the users.

### SUMMARY

There is provided a method of social interaction, comprising the steps of providing a network having a set of mobile devices associated with individuals; identifying a plurality of units of at least one subset of the set of mobile devices, at least one unit of the plurality of units comprising a group of mobile devices formed based on common social connections between individuals; characterizing the units by one or more characteristics; ranking a compatibility of units by comparing the one or more characteristics; causing at least one invitation or message to be transmitted over the network from a sending unit to a receiving unit; and sharing contact information of the units once an invitation has been accepted.

According to another aspect, the mobile devices may track geographic location.

According to another aspect, the social connections may comprise common contacts in a contact list stored on each mobile device.

According to another aspect, at least one unit may be a commercial enterprise. The commercial enterprise may transmit messages or invitations to units based on the one or more characteristics. The one or more characteristics may comprise at least one of: number of mobile devices in the at least one unit, current location, ages of the owners of the mobile devices, genders of the owners of the mobile devices, preferences of the at least one unit, shared preferences in profiles on mobile devices in the at least one unit, and historical trajectories. Statistics may be transmitted to the commercial enterprise representing the effectiveness of the messages or invitations to the commercial enterprise.

According to another aspect, the method may further comprise the step of characterizing the units comprises compiling at least one of characteristics entered after the unit has been identified and characteristics stored in the mobile device that are common to the mobile devices in each unit.

According to another aspect, the one or more characteristic may comprise at least one of: number of mobile devices in the at least one unit, current location, ages of the owners of the mobile devices, genders of the owners of the mobile devices, preferences of the at least one unit, shared preferences in profiles on mobile devices in the at least one unit, and historical trajectories.

According to another aspect, the method may further comprise the step of storing rankings for at least one unit based on feedback from another one or more units.

According to an aspect, there is provided a network for making social interactions. The network comprises a plurality of mobile devices associated with individuals, the mobile devices having transceivers for transmitting and receiving information, a data entry interface, a display, and a location sensor. A server is in communication with the mobile devices, the server having software that compares contact lists of the plurality of mobile devices to identify potential units that are within a predetermined radius of other mobile devices, the potential units comprising mobile devices with common contacts in the contact lists, and the software notifying the mobile devices of a potential unit and storing the potential unit as an active unit upon receiving approval from the mobile devices.

According to another aspect, at least one unit may be identified in the server as a preapproved unit, the preapproved unit being identified as an active unit server that forms the units automatically once the mobile devices are within the predetermined radius.

According to another aspect, the server software may further comprise instructions to rank units according to compatibility.

According to another aspect, compatibility may be determined based on factors selected from unit characteristics and location.

According to another aspect, unit characteristics may comprise at least one of: number of mobile devices in the active unit, current location, ages of the owners of the mobile devices, genders of the owners of the mobile devices, preferences of the active unit, shared preferences in profiles on mobile devices in the active unit, and historical trajectories.

According to another aspect, the server software may further comprise instructions to transmit invitations or messages to units for social interaction.

According to another aspect, the server software may further comprise instructions to transmit contact information once an invitation has been accepted.

According to an aspect, there is provided a method of social interaction, comprising the steps of: tracking a plurality of trajectories of more than one unit, each unit comprising one or more mobile devices having a location sensor and connected to a network; determining a pattern of trajectories for each of the more than one unit, the pattern of trajectories comprising locations, direction of travel, and times; ranking the compatibility of units by comparing the characteristics of each unit, at least one characteristic comprising the pattern of trajectories; and sending a message or invitation over the network to notify units of a potential social interaction.

According to another aspect, the message or invitation further comprises proposing a meeting place and time based on the pattern of trajectories of each unit.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a schematic view of a network.

FIG. 2 is a schematic of the system used to track individuals with overlapping trajectories.

FIG. 3 is a schematic depicting a grouping process.

FIGS. 4-6 are examples of connections between individuals based on a contact list.

FIGS. 7 and 8 are flow charts of the steps in a grouping method.

FIGS. 9 and 10 are flow charts of the steps in a group-to-group social interaction.

FIG. 11 is a flow chart of the lifecycle of a group-to-group social interaction.

FIG. 12 is a flow chart of a user's location being tracked by the method.

FIG. 13 is a flow chart of the steps in a server relayed social interaction.

FIG. 14 is a flow chart of the steps in a business-to group-interaction.

FIG. 15 is a flow chart of the steps in introducing a group to another group.

FIGS. 16 and 17 are flow charts of the steps in a method to pair individuals based on trajectories.

FIGS. 18-25 are screenshots of a mobile device used to implement the flowcharts described above.

### DETAILED DESCRIPTION

This relates to a method and apparatus for facilitating or initiating group-based social interactions. Individuals are grouped using known relationships or by cross-referencing using an existing list of contacts, such as from a list of contacts that a person may maintain in a smart phone or other electronic device, or from a social network. An event or promotion may then be initiated based on the group's location, proximity to other groups, etc. as will be apparent from the description below, and may involve another group or an organization such as a business. Other aspects and details will be apparent from the description below. While groups are described below in a preferred embodiment, it will be understood that each group may be considered a “unit,” and other units may include individuals or commercial enterprises that may interact with other units made up of individuals or other groups as well.

The examples discussed below are with respect to a mobile device such as a smart phone that can locate an individual using GPS or based on the proximity to cell phone towers. Furthermore, the grouping is done by cross-referencing an individual's list of contacts. This may be on the mobile device, but it may also be on a separate device that also interacts with a server, or on the server itself. Variations, such as other types of mobile devices, other approaches to determining location, etc., will be apparent to those skilled in the art, and the method and apparatus may be modified accordingly.

In one example, the method relates to a location-based many-to-many social interaction. Particularly, using a new computerized method of grouping friends and colleagues. The apparatus that employs the method may use a server or through peer-to-peer networking using the mobile devices themselves.

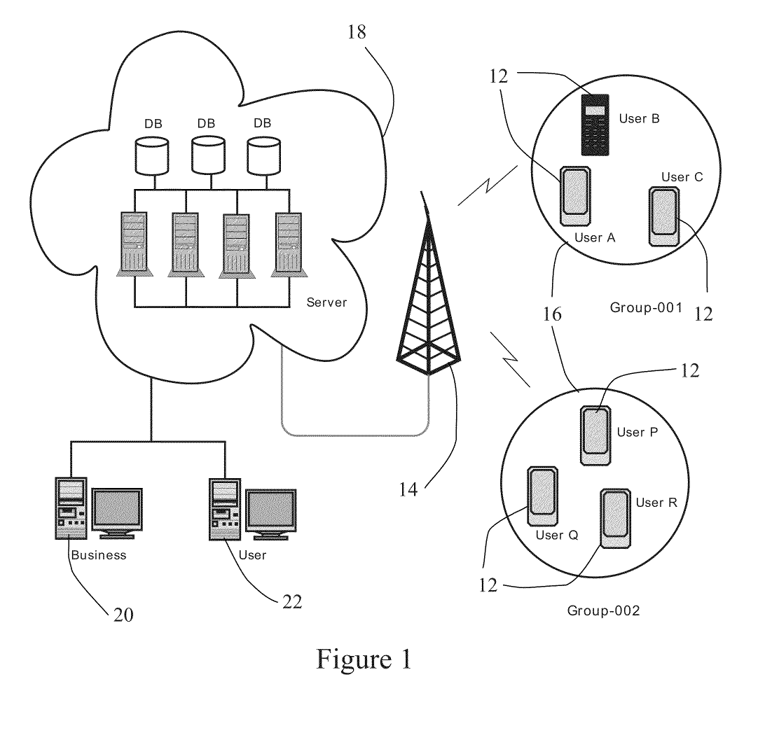

Referring to FIG. 1, there is shown an example of a network that may be used. The network includes mobile devices 12 in communication with a wireless antenna 14. As mentioned above, mobile devices 12 are capable of determining their location, either by proximity to one or more antennas (such as a cell tower), by GPS, or by other techniques that allow the user's location to be determined. As depicted, mobile devices 12 are grouped into groups 16, as will be described in more detail below. Wireless antenna 14 are preferably in communication with servers 18 and databases 20. These may be controlled by the service provider and used, for example, to keep groups and individuals anonymous until the decision is made to meet, and to manage the transmission of messages between groups or individuals. There may also be other users 22 connected in the network, such as individuals or businesses that can send messages, advertise, etc. These may be connected over a wireless or wired connection.

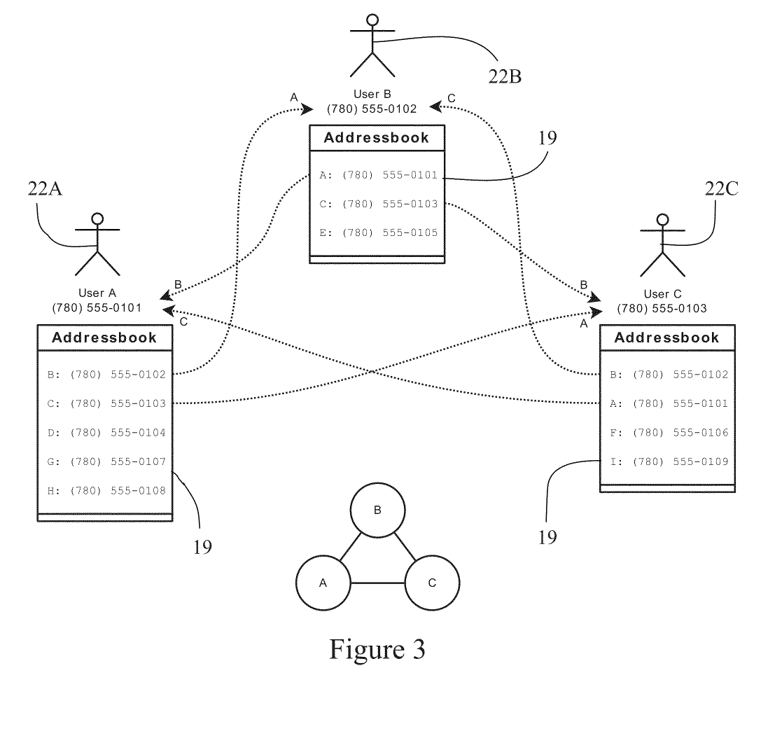

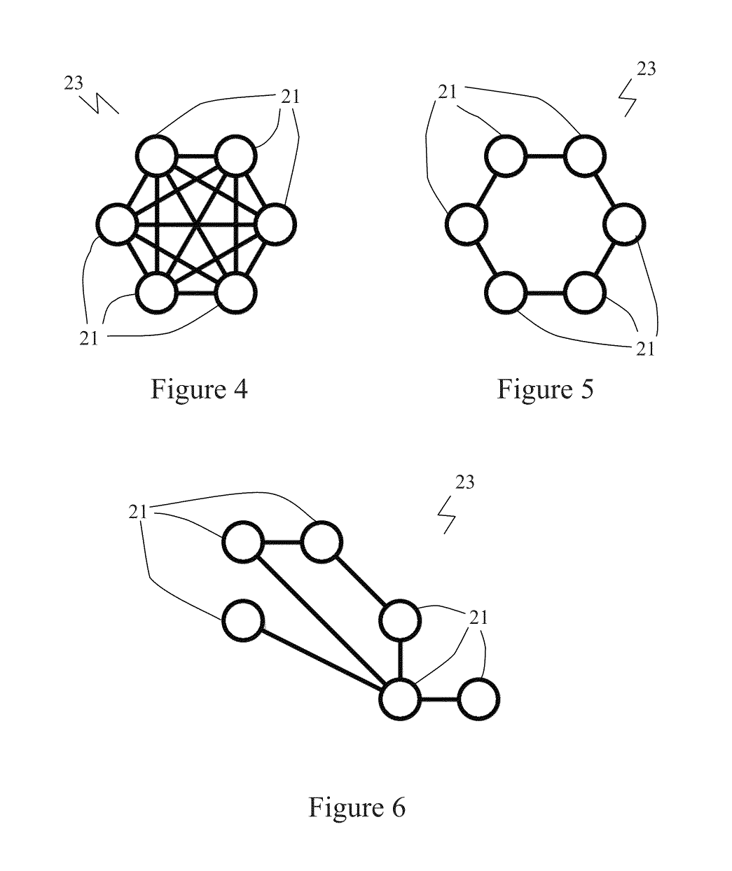

Grouping method—Grouping people is done using computerized devices' contacts or address books 19. A group is preferably made from reviewing the contacts in an individual's contact list, and identifying individuals common to all. For example, referring to FIG. 3, from User A 22A has User B 22B and User C 22C in their contact list, while User B 22B has User A 22A and User C 22C, and User C 22C has User A 22A and User B 22B. In this case, Users A, B, and C 22A, 22B, and 22C all know each other and are placed in a group. As can be seen, there are other contacts in each of the contact lists 19 for Users A, B, and C 22A, 22B, and 22C. Even if these individuals were present, they would not be placed into the group with Users A, B, and C 22A, 22B, and 22C, as they are not known by the entire group. Contacts may be a phone number (mobile or fixed), an email address, etc. Group members may also be manually added or removed. A person may have several groups and may be in several groups. Alternatively, a person may be required to select a group that they will be a part of at any given time. This type of arrangement is depicted in FIG. 4, where each node 21 of a network 23 is connected with other nodes, making a group of up to six users possible. Referring to FIGS. 5 and 6, this is not the case. In these examples, there would be six possible groups of only two users each.

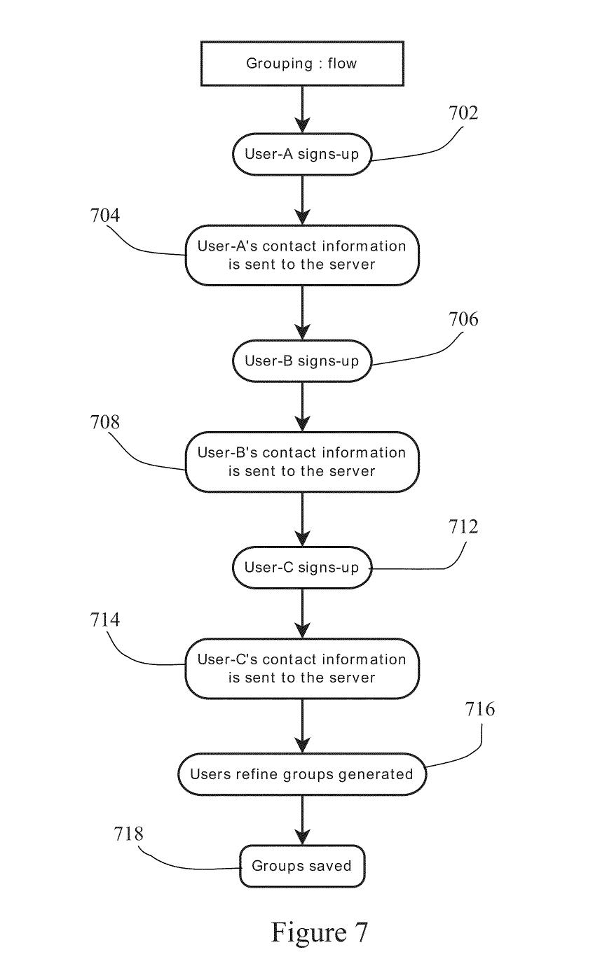

Referring now to FIG. 7, there is shown a flow chart of the overall process involved in establishing a group. In step 702, User A signs up, and User A's contact information is sent to the server in step 704. User B signs up and similarly has the contact information sent to the server in steps 706 and 708, respectively. At this point, since User A and User B both have each other in their contact list, the server will identify a possible group with User A and User B and may notify the users, depending on the preferences. In steps 712 and 714, User C signs up and has the contact information sent to the server. The server then sets up a possible group of Users A, B, and C and notifies the users. The users then have the option of refining the groups in steps 718, and the groups are saved. The group may be stored on the server, on the respective devices of each user, or both.

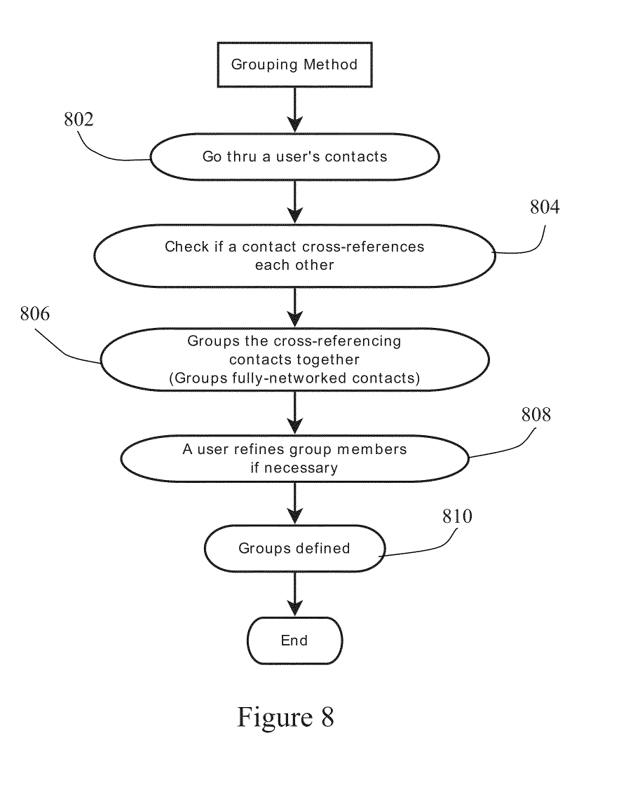

Referring now to FIG. 8, the grouping method is shown in more detail. Once the method starts, each user's contact list is reviewed and cross-referenced or compared to other user's contact lists in steps 802 and 804 to see whether there are any similarities. At step 806, the common contacts are then grouped together. This is preferably done as described above, where groups are only formed by users that appear in every other user's contact list. Depending on the contact lists and the users present, there may be more than one group formed, or a user may be prompted to decide what group they wish to join. Alternatively, rather than grouping A, B, and C, the group may be refined to A and B, or B and C. If desired, another option may be to set up a “sub-group” within a group. At step 808, members may be added or removed from a particular group. For example, a guest that may not be known to everyone or that may not appear in everyone's contact list may be manually added to the group. This may be done by amending the group to include the other person, which may be necessary if the person does not have a mobile device or is not in everyone's contact list, or by having one user send out the contact information for the user to be added to the other group members through the system to be accepted by the others. At step 810, the defined groups may be defined and saved for later use. Once a group has been defined, it may not be necessary to prompt for the group to be formed or to accept the group at a later date. Instead, the group may automatically form when the users come into close proximity with each other.

Social interaction—The purpose of forming the groups is to facilitate or initiate interactions with the group. Once grouped, the group can engage socialinteraction. The number of member engaging social interaction may not necessarily be the same number of the group. For example, on a certain occasion, only three friends from a five member group may hang out. In this example, they will be engaging social interaction as a 3-people group (Group-01) for the occasion. When another 3-people engaged group (Group-02) is looking for a group for social-interaction, ‘Group-01’ will be one of matching groups.

When a group (Group-01) searches other groups, it may look for characteristics such as: same number of members in a group, proximity of groups, etc. Attributes of groups may also be considered in searching, as specified by the groups. A group's attributes may be determined by a tag specified by the group, or by common attributes among engaged members. Tagging may be done by members in the group or others to characterize the group. Alternatively, or in addition, common attributes shared among the members of the group may be determined automatically by a computer, server or the mobile devices as they communicate. For example, if all members of the group are male or like basketball, the group may be tagged with “male” or “basketball” without having to enter the tag.

A group will be a unit for a social-interaction. For example, a group of a certain number of people that want to play street basketball can find another group of the same number of people nearby. In this example, the former would initiate interaction by looking for groups with same number of people near with keyword or message containing “street basketball”. The message will be posted and with a high priority to near-same-number-grouped people, and searchable. Near groups with a certain tag will be notified with permission. A notification may be done through a server, peer-to-peer network, or instant message services, such as SMS. Other ways of sending notifications may also be used, as will be recognized by those skilled in the art.

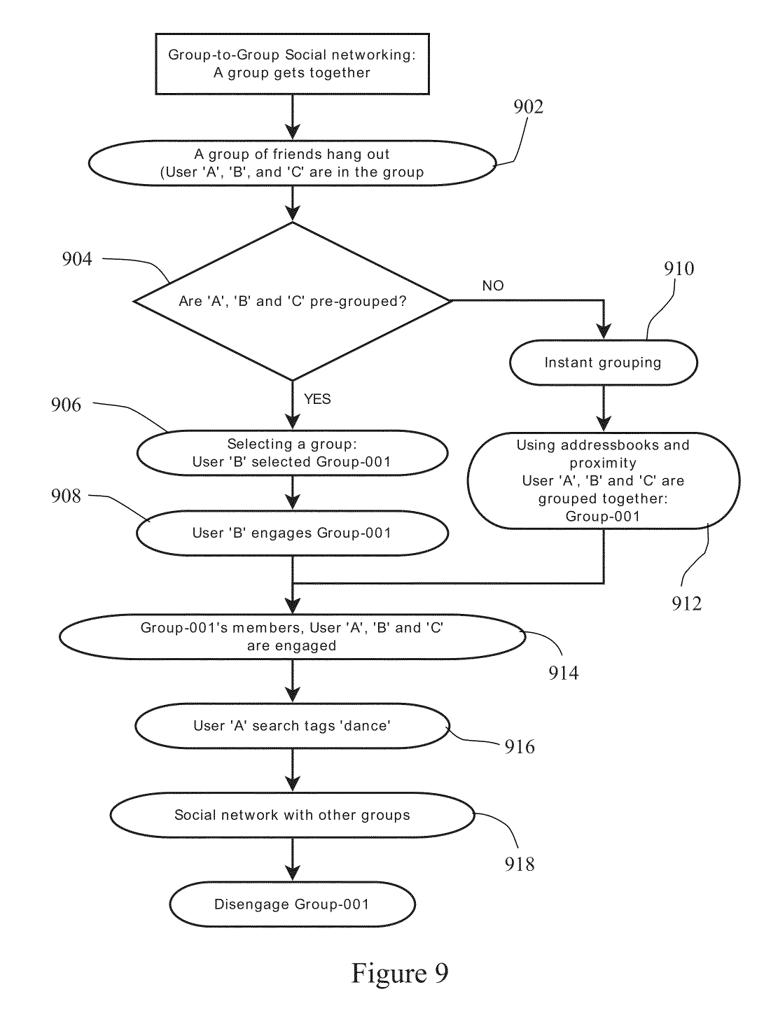

Referring now to FIG. 9, an example of social networking is shown. The first step in 902 is to form a group, where the mobile devices detect the proximity of other individuals in their contact list, or are added manually if they do not have a mobile device. A user's proximity may be determined by logging the location periodically, such as every 15 minutes, then comparing this location with other users. If each user's last location is within a certain distance, such as 20 meters, they may be considered “close, and available to be grouped. The time and distance may be varied, and the detection may be prompted manually if the users wish to recognize their group more quickly. At step 904, the users may be prompted to select a group, moving to steps 906 and 908, where the group is selected and engaged, or formed automatically, moving to steps 910 and 912, where the group is automatically formed based on the users present. The default will preferably be to prompt for the group, but will depend the preferences stored by the users.

At step 914, the group is identified and the members are “engaged” in the group. Once engaged, the group may be ready for social networking, and is searchable by other groups. The group will preferably be searchable first by the group size, but may also be searchable based on other criteria.

The group may then tag themselves with their current interest. In the example in step 816, a user in the group has tagged the group with “dance, in which case the system will search for other groups with the “dance” tag, or “dance” attributes. Generally, attributes may be considered to be interests or characteristics found in the profile of an individual or group profile (for example, one user may have one stored group with a “basketball” attribute, another group with a “dance” attribute, and either group may be tagged with “beer,” depending on their particular interests). The social interaction between different groups occurs in step 918. The history of interactions may be stored in the server as well. This may be used to give a higher priority to a particular group that interacts more frequently, or mark a group as “active” for future reference. It may also recognize other groups that the group has interacted with before. The system may also permit a group to be ranked or commented on.

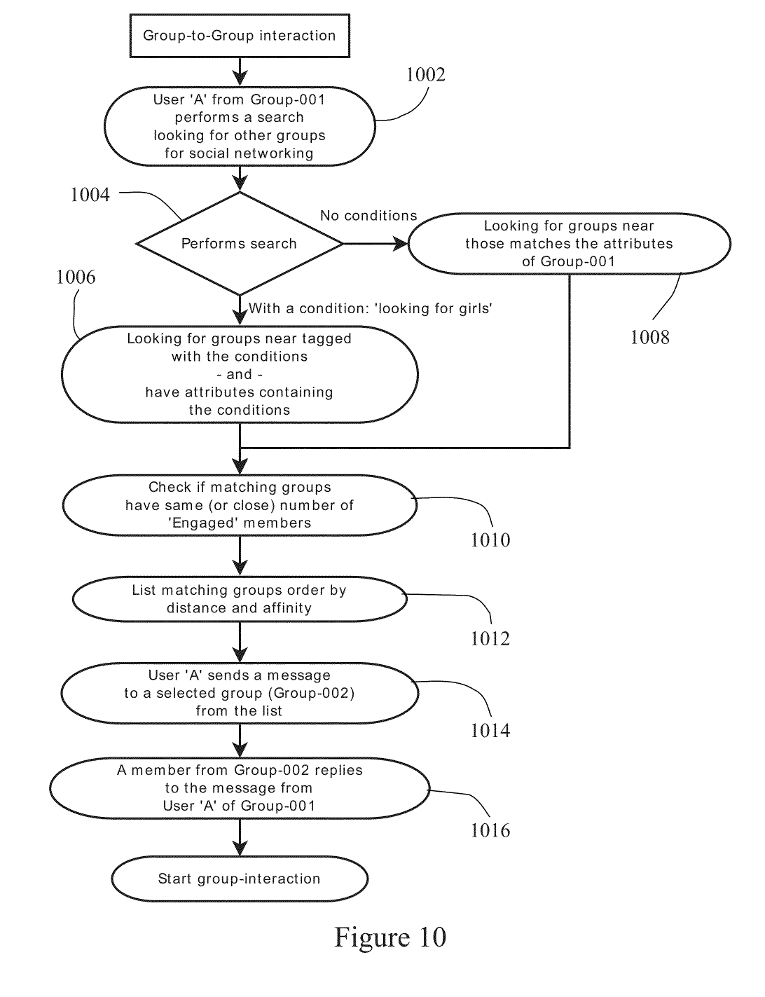

More detail related to interactions between groups is shown in FIG. 10. In step 1002, a user may perform a search on behalf of the group. The search in step 1004 may be conditional on certain tags, leading to step 1006, or unconditional, leading to group 1008. The conditional search may be useful, for example, when searching for dance partners, or dance partners of a particular gender. The size of groups may then be compared at step 1010. In step 1012, the results are ranked according to distance and compatibility. In step 1014, a user on behalf of one group may send a message to another group, which may be transmitted to the entire group, or to a designated member of the group. A reply occurs in step 1016, and a decision is made whether to interact or not. Up to this point, the interaction is preferably anonymous aside from attributes or tags, with more information being shared if interaction occurs.

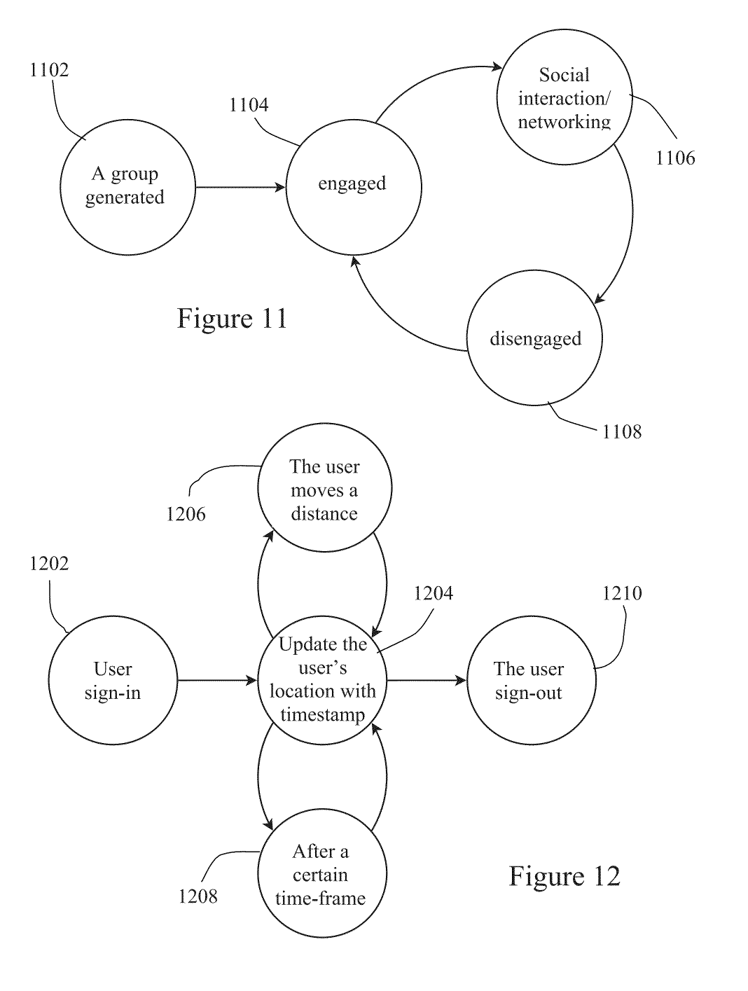

Referring to FIG. 11, the overall lifecycle of a group is depicted. Once a group is formed in step 1102, the group is either engaged at step 1104, at which point it is prepared to move on to social interaction with another group at step 1106, and then becomes disengaged at step 1108. The group will be prepared to engage in social interaction again once the group becomes engaged again in step 1104. Of course, it is possible to disengage the social interaction with another group while maintaining the same group, i.e. moving from step 1106 back to 1104. Referring to FIG. 12, the lifecycle of a user's location is shown. Once signed in at step 1202, the user's location is time stamped at step 1204. The location may be time stamped again if the user moves a certain distance (step 1206) or after a certain time period (1208). This continues until the user logs out at step 1210.

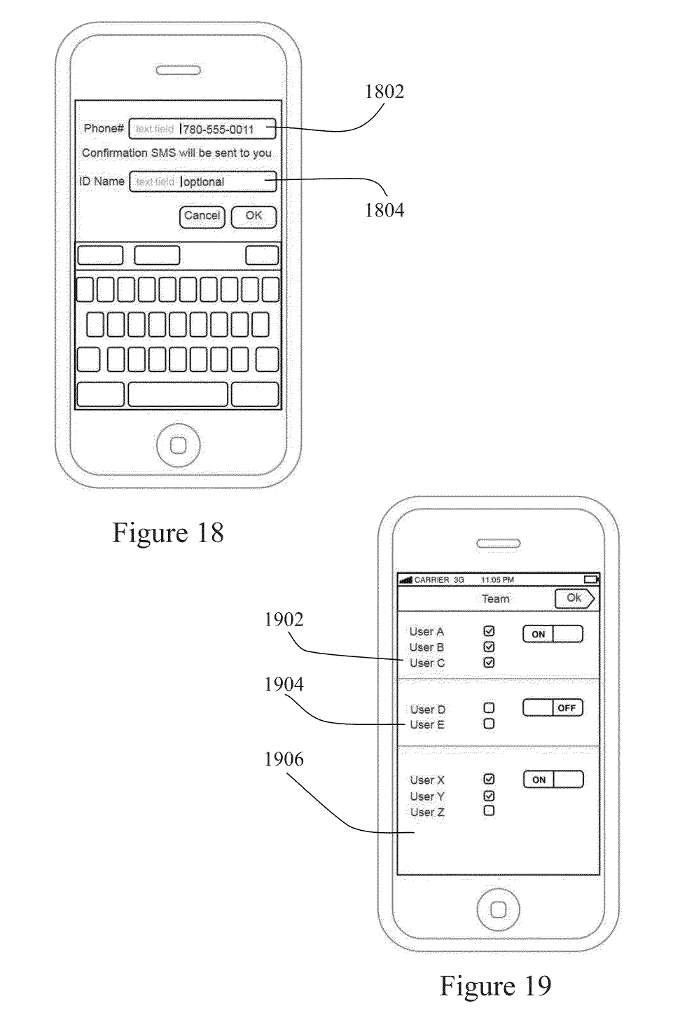

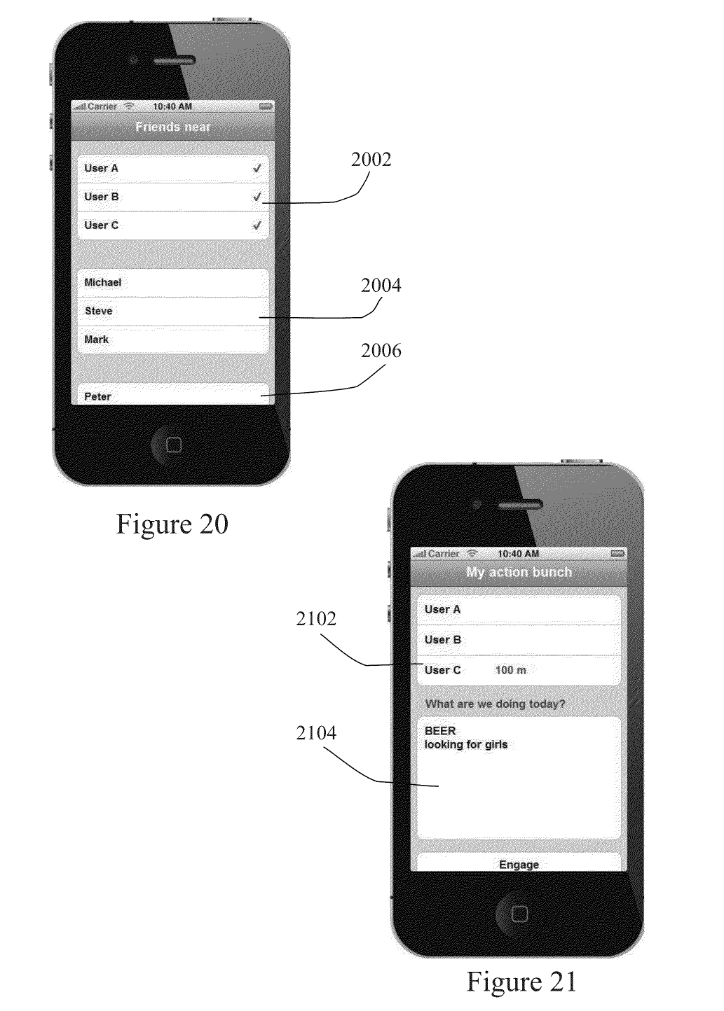

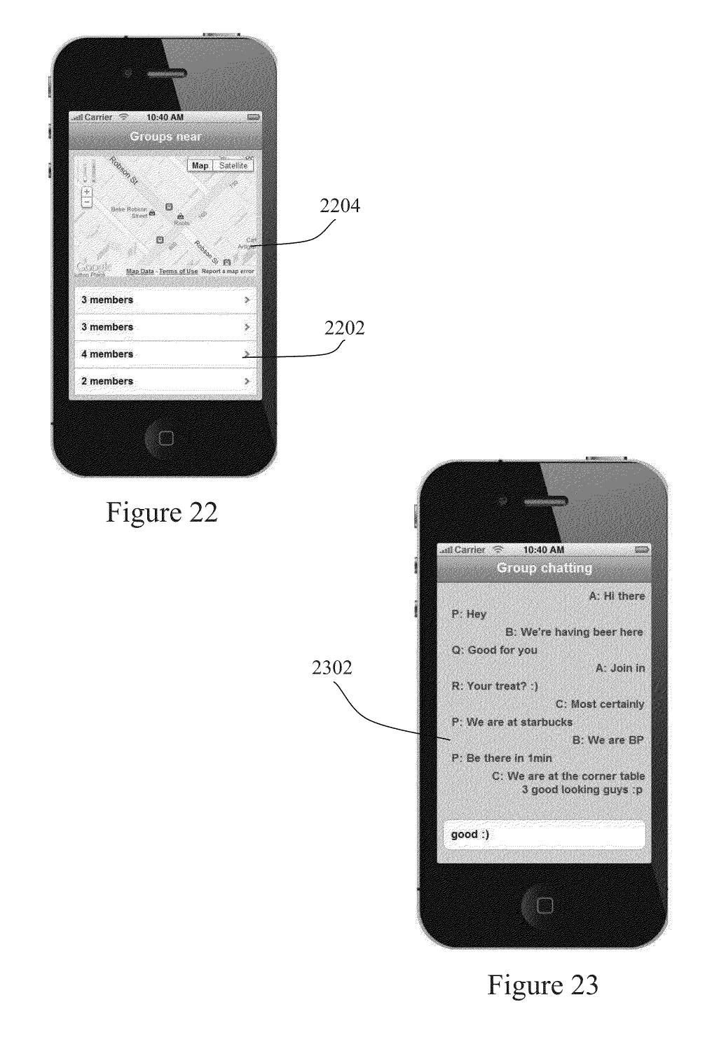

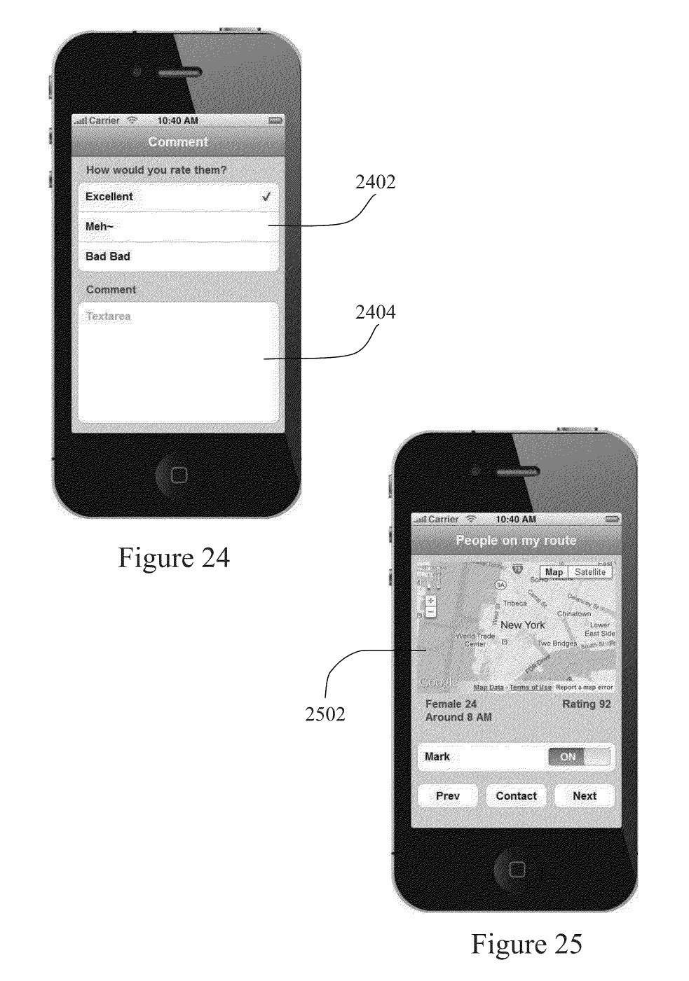

System interface—Referring to FIGS. 18-24 depict examples of screenshots related to various steps taken to establish a group and interact with other groups. FIG. 18 depicts a sign-up screen, where a user confirms their phone number at field 1802, which will be a unique identifier. An optional ID name may be entered in field 1804. In FIG. 19, the groups are fine-tuned, and various groups are selected. For example, in box 1902, users A, B, and C were accepted as a group, while in box 1904, the group was rejected, and in box 1906, only two possible group members were included in the group. Once the group is formed, messages may be sent to the group members as confirmation. Referring now to FIG. 20, a screenshot of a device is shown, where friends in a group that are close are shown. This may also be based on pre-defined groups, such as groups 2002, 2004, and 2006, and may be useful in determining when everyone has arrived, or may indicate the distance of each member from the group. Referring to FIG. 21, once the group has been defined in area 2102, the current theme or tags may be set in a text box 2104. This may be visible to other groups. Referring to FIG. 22, after the group has been formed, other groups in close proximity are shown in a list 2202, ranked in order of compatibility. By selecting a particular group, more information can be seen. The groups may be located on a map 2204, which may also control the groups shown in list 2202. For example, by zooming in or out, the number of groups displayed may change. In one example, any group with a person found to be equal or less than two or three degrees of separation may be indicated. In addition, previous interactions may also be indicated. Referring to FIG. 23, once interaction has been initiated, the groups may participate in an anonymous chat 2302, with messages from one group on one side of the screen (e.g. A, B, C messages appear on the right), and the other group on the other side (e.g., P, Q, R messages appear on the left). Referring to FIG. 24, after or during the interaction, the group may be rated 2402 in various ways, and an optional comment section 2404 may be included.

One-to-many social-interaction—This example may be particularly location based, and may be used for localized instant gathering or instant emergency response. A person may initiate a gathering with a message containing what kind of gathering he or she wants. The message will be posted and searchable to people that are near. With a user's permission, it will be notified to the person with relating attributes. For example, the person may issue an emergency situation about car accident, which will then be posted and searchable to people that are near. Another person near with an ‘emergency response’ tag or attribute will be notified if the person allows a notification who happened to be a firefighter off duty hanging around nearby with emergency situation expertise could come for help. Exact location of the accident can be revealed if necessary. This may also be used to create a “social mob”, where a person may send a notification that something of particular interest was found. A notification may then be sent to those open to receiving these types of notifications.

Location based social commerce (business to group interaction)—This example may be used to connect groups close to a particular business. For example, a business may target specific groups based on size or interests, or tailor their event or promotion to a group that is in a particular area. Traditionally, this kind of search occurs in the other way, where a user initiates a search by looking around for a point of interest. However, in this suggested method, a business may initiate the search by looking for a target market/people and tailor the promotion or event accordingly. For example, a business may look up how many of groups consisting a certain number of people are near. The business may be provided with information such as how many groups in the area are likely take offers or events by checking history of accepting offers of the groups. Once a business decides on the target group or groups, it can send out offers or events through an instant message or email. In this case, the business would likely reveal its contact and street address or exact location determined by GPS.

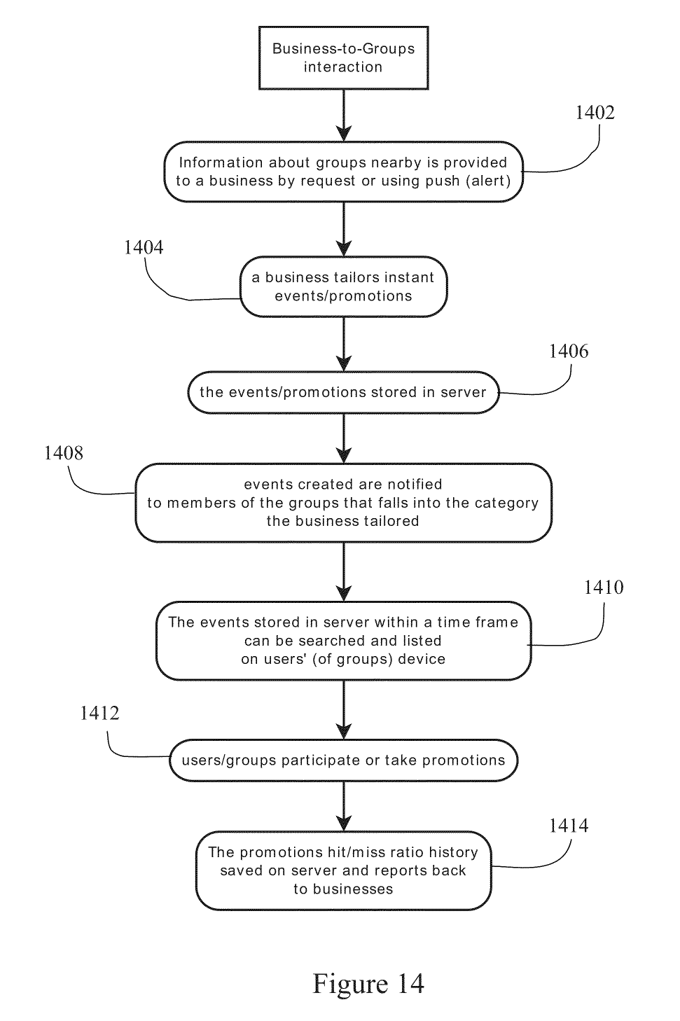

Referring to FIG. 14, an example of a flow chart for this approach is depicted. In step 1402, a business may be notified, either by push notifications (alerts) or by request. In step 1404, a business may tailor the event or promotion for the groups in the area. For example, a business may target certain groups with a certain number of members, specific attributes or tags, etc. This promotion may then be stored in the server at step 1406, and at step 1408, groups are notified of the promotion when they are within a specified distance of the promotion. The distance may be flexible, and may depend on the groups characteristics (e.g. access to a vehicle, on foot, etc.). At step 1410, a group may also search for specific events, which are then listed so a user can search and review. At step 1412, the users or groups accept the promotion, and at step 1414, feedback, such as acceptance ratio, attributes of those that accept, ratings, comments, etc. may be reported to the business.

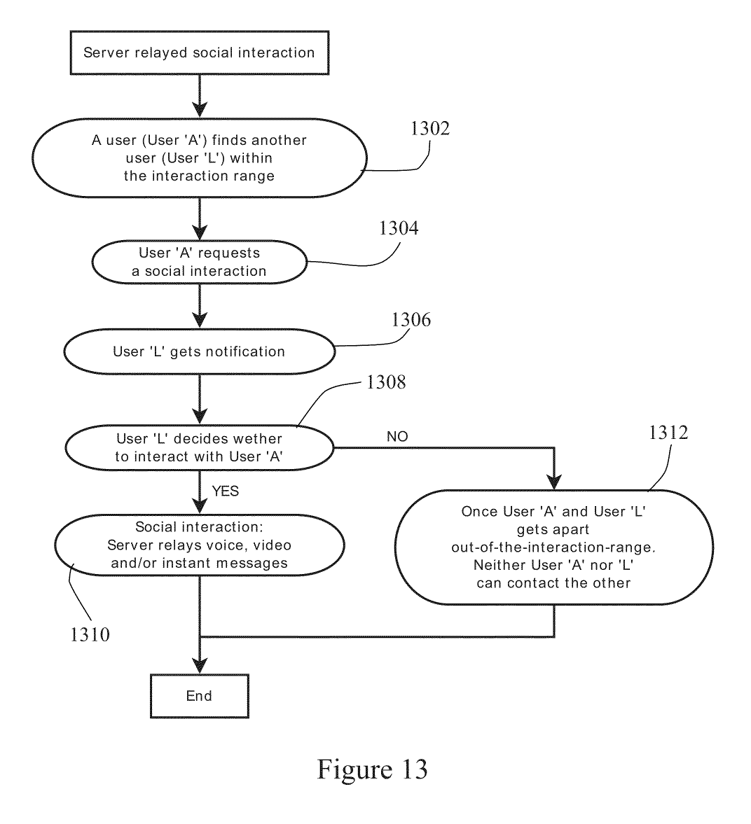

One-to-one social-interaction—Referring to FIG. 13, an example of one-to-one social interaction is shown. In step 1302, User-A may be notified, or may search for, another user (User-L) that may be interacted with. At step 1304, User-A sends a message to User-L and at step 1306, User-L is notified. Note that, in this example, it may be that User-A and User-L may not know each other. A user may hide their status if they do not wish to interact, or may blacklist users if they wish to avoid all contact with a particular user. At step 1308, once notified, User-L can either accept User-A's invitation and move to step 1310, or reject the invitation and move to step 1312. At step 1312, if the individuals move apart without making a decision or the invitation is rejected, the connection between the users is broken and no further communication is possible. At step 1310, if the invitation is accepted, a connection may be set up between the users using a variety of approaches, such as instant messaging, SMS, voice, video, Skype®, etc. Preferably, until both users indicate their willingness, no personal information is shared. In other words, the contact is anonymous until step 1310. Alternatively, User A may share contact information with their initial contact in step 1304.

Social networking based on common trajectories—One example of one-to-one social interaction is based on common trajectories rather than proximity at a point in time, where people or groups are connected based on trajectory history. While the discussion below is in the context of one-to-one interaction, it will be understood that similar principles also apply to groups. However, as groups are more likely to be stationary at a single location, it is more likely to be applied to individual.

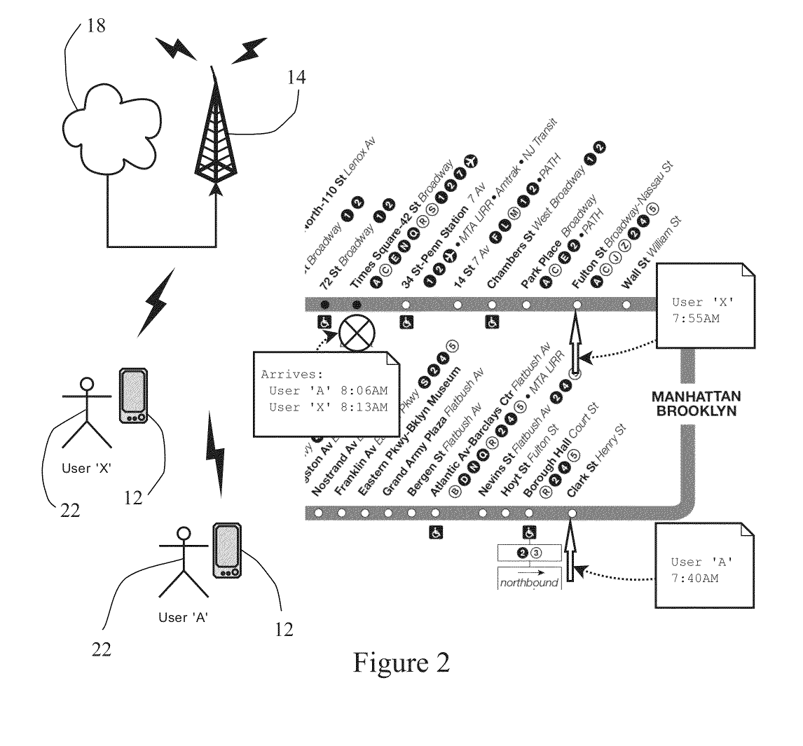

A person may find or be notified of another person sharing a common path or crossing. Using a person's trajectory saved in a server or a mobile device, the person's repeating path at a certain time period can be determined. For example, during weekdays, the commute route can be determined with user's saved trajectory. Another person who may share a part of the route at the same time period can be found. With high priority and with common attributes and percent of portion sharing trajectory, most appropriate people can be found. One example of this application may be identifying a potential car-pooling group. Another example is shown in FIG. 2, where User ‘A’, male, commutes from Clark St. to Times Square in the morning weekdays and User ‘X’, female, commutes from Fulton St. to Times Square. The system compares the times and trajectories and if a match occurs, may notify ‘A’ and ‘X’ of another person sharing their trajectory. The notification may also be based on whether the other person meets predetermined criteria of who each user is willing to interact with.

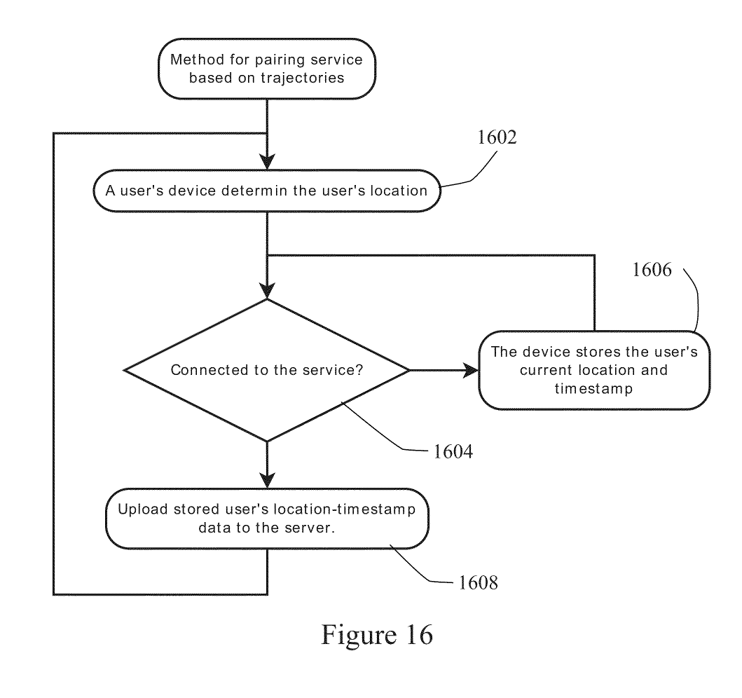

An example of pairing based on trajectories is shown in FIG. 16. In one example, the device records the user's travel trajectory and timestamp. This is done by determining the user's location by the mobile device at step 1602. If the device is not connected to the servers, or is not logged in at step 1604, the device records the location or trajectory and timestamp at step 1606, and repeats the process. Once the device is logged in to the server, the location and timestamp information is uploaded to the servers at step 1608. This information is then used to consider the user's trajectory and travel plan.

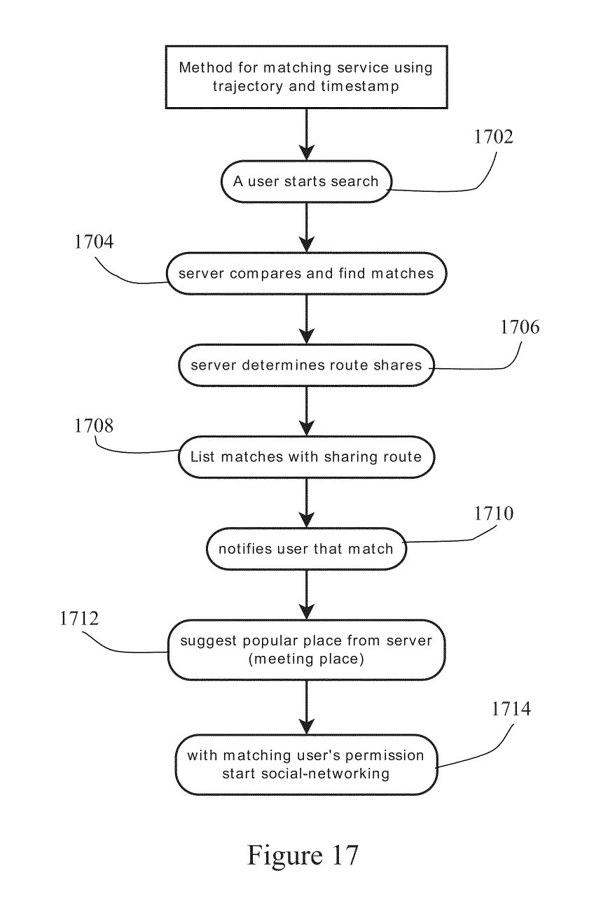

An example of a flow chart is shown in FIG. 17. In step 1702, a user initiates a search, and the server compares routes in step 1704. In step 1706, the server decides whether the route is a common route, and then lists shared routes in step 1708. The list may be ranked according to, for example, the similarity of the route, time the route is taken, the compatibility of the users, and the preferences indicated by each user. The tolerances may be adjusted based on preferences and experience. In step 1710, the users are notified of a potential match, and at step 1712, the server may recommend a popular meeting place that is close to the shared route match. After that, at step 1714, the users may share contact information or not, and each user may rate or comment the meeting, and/or the quality of the location.

An example of an interface is shown in FIG. 25, where a map 2502 is shown, which may depict the user's route and the common trajectory of other users. Details of the other users may appear in association with that route, such as the age, gender, etc. as well as the timeframe and rating, comments, etc. The screen also provides options to contact this person (e.g. SMS, MMS, IM, etc., preferably anonymously through the server), or move to search for another user.

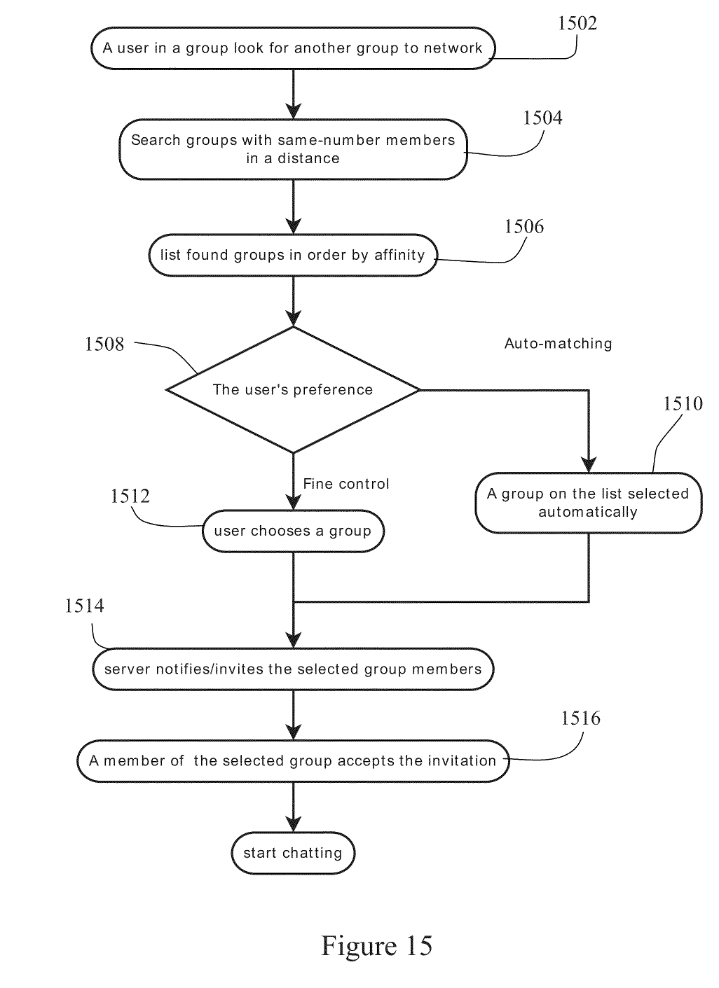

Location-based ad-hoc chatting—The system may also permit ad-hoc chatting between groups or users. Referring to FIG. 15, at step 1502, a user (either an individual or on behalf of a group) starts looking for another unit (e.g. individual or group). At step 1504, the search may be for groups with the same number of members within a particular geographic area and at step 1506, the groups are listed based on their proximity, compatibility, etc. At step 1508, the requester may be automatically matched, where the system chooses the highest ranked unit at step 1510, or the requester may be prompted to make the choice at step 1512. The server then notifies the unit at step 1514 of the invitation, and the invitation is either accepted or rejected at step 1516. Once the invitation is accepted, chatting starts at step 1518.

Server relayed social interaction—To alleviate privacy concerns, initial social-interactions are preferably server relayed, such that no direct contact will be revealed to the other groups or persons. Using this approach, one party wouldn't know who exactly they found through a search and wouldn't get any contact information but through server relayed interaction. Server relayed interactions may include voice chatting, instant messages, etc. One consequence of this is that, if one party found another party through a search but decided not to interact with them at the moment, in general they would not be able to contact that group later once either party is out of the search range. An option to make a direct contact may be provided if a user wanted to reveal the contact. For example, a business participating in social commerce through this system would want to reveal its contact, or if the group wanted to share contact information after making an initial anonymous contact.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. The scope of the claims should not be limited by the preferred embodiments set forth in the examples, but should be given the broadest interpretation consistent with the description as a whole.

1. A method of social interaction, comprising the steps of:
providing a network having a set of mobile devices associated with individuals;
identifying a plurality of units of at least one subset of the set of mobile devices, at least one unit of the plurality of units comprising a group of mobile devices formed based on common social connections between individuals;
characterizing the units by one or more characteristics;
ranking a compatibility of units by comparing the one or more characteristics;
causing at least one invitation or message to be transmitted over the network from a sending unit to a receiving unit; and
sharing contact information of the units once an invitation has been accepted.

2. The method of claim 1, wherein the mobile devices track geographic location.

3. The method of claim 1, wherein the social connections comprise common contacts in a contact list stored on each mobile device.

4. The method of claim 1, wherein at least one unit is a commercial enterprise.

5. The method of claim 4, wherein the commercial enterprise transmits messages or invitations to units based on the one or more characteristics.

6. The method of claim 5, wherein the one or more characteristics comprise at least one of: number of mobile devices in the at least one unit, current location, ages of the owners of the mobile devices, genders of the owners of the mobile devices, preferences of the at least one unit, shared preferences in profiles on mobile devices in the at least one unit, and historical trajectories.

7. The method of claim 5, further comprising the step of transmitting statistics representing the effectiveness of the messages or invitations to the commercial enterprise.

8. The method of claim 1, wherein characterizing the units comprises compiling at least one of characteristics entered after the unit has been identified and characteristics stored in the mobile device that are common to the mobile devices in each unit.

9. The method of claim 1, wherein the one or more characteristic comprise at least one of: number of mobile devices in the at least one unit, current location, ages of the owners of the mobile devices, genders of the owners of the mobile devices, preferences of the at least one unit, shared preferences in profiles on mobile devices in the at least one unit, and historical trajectories.

10. The method of claim 1, further comprising the step of storing rankings for at least one unit based on feedback from another one or more units.

11. A network for making social interactions, comprising:
a plurality of mobile devices associated with individuals, the mobile devices having transceivers for transmitting and receiving information, a data entry interface, a display, and a location sensor; and
a server in communication with the mobile devices, the server having software that compares contact lists of the plurality of mobile devices to identify potential units that are within a predetermined radius of other mobile devices, the potential units comprising mobile devices with common contacts in the contact lists, the software notifying the mobile devices of a potential unit and storing the potential unit as an active unit upon receiving approval from the mobile devices.

12. The network of claim 11, wherein at least one unit is identified in the server as a preapproved unit, the preapproved unit being identified as an active unit server that forms the units automatically once the mobile devices are within the predetermined radius.

13. The network of claim 11, wherein the server software further comprises instructions to rank units according to compatibility.

14. The network of claim 13, wherein compatibility is determined based on factors selected from unit characteristics and location.

15. The network of claim 14, wherein unit characteristics comprise at least one of: number of mobile devices in the active unit, current location, ages of the owners of the mobile devices, genders of the owners of the mobile devices, preferences of the active unit, shared preferences in profiles on mobile devices in the active unit, and historical trajectories.

16. The network of claim 11, wherein the server software further comprises instructions to transmit invitations or messages to units for social interaction.

17. The network of claim 11, wherein the server software further comprises instructions to transmit contact information once an invitation has been accepted.

18. A method of social interaction, comprising:
tracking a plurality of trajectories of more than one unit, each unit comprising one or more mobile devices having a location sensor and connected to a network;
determining a pattern of trajectories for each of the more than one unit, the pattern of trajectories comprising locations, direction of travel, and times;
ranking a compatibility of units by comparing characteristics of each unit, at least one characteristic comprising the pattern of trajectories; and
sending a message or invitation over the network to notify units of a potential social interaction.

19. The method of claim 18, wherein sending a message or invitation further comprises proposing a meeting place and time based on the pattern of trajectories of each unit.
